(19) United States
(12) Patent Application Publication
(10) Pub. No.: US 2006/0016248 A1
(43) Pub. Date: Jan. 26, 2006

(54) Thermoelectric Circuits Utilizing Series Isothermal Heterojunctions

(76) Inventor: Kevin Walsh, Atlanta, GA (US)

Correspondence Address: Kevin Walsh, P.O. Box 170476, Atlanta, GA, 30317, US

(21) Appl. No.: 11/161,182

(22) Filed: Jul. 26, 2005

Related U.S. Application Data
(60) Provisional application No. 60/591,124, filed on Jul. 26, 2004.

(51) Int. Cl. G01M 3/04

(52) U.S. Cl. 73/40

(57) ABSTRACT

Isothermal semiconductor(s) forming a conductive bridge at the two junctions of the of a thermoelectric circuit legs are used to produce an increase the Seebeck coefficient of the circuit. For the circuit legs, a p- and n-type semiconductor pair is preferred in which the valence and conduction bands of the n-type are higher in energy (i.e. having a lower electron affinity) than those of the p-type leg. The isothermal semiconductor may be either p- or n-type. If it is n-type, its conduction band lies below (i.e. having a higher electron affinity) that of the n-type leg, and if it is a p-type material, its valence band lies above (i.e. having a lower electron affinity) that of the p-type leg. This arrangement results in an increase thermal conversion efficiency in comparison to the corresponding TE circuit that does not have the isothermal semiconductor present.

### BACKGROUND OF THE INVENTION

In its most basic form a TE converter consists of two arched lengths of conductors that are made to contact each other at each end to form a closed loop. The resulting circuit has two “legs” and two junctions, as shown in FIG. 1. The two conductors must be made of different materials. Usually an n-type semiconductor is paired with a p-type semiconductor. Typically small band gap semiconductors of less than 1.5 eV are used. Although metals may be used as well, they tend to display relatively little change in electron potential with temperature and are therefore less suited than semiconductors. The terms n-type and p-type refer to the predominant charge carrier type. In n-type semiconductors the charge carriers are negatively charged mobile electrons, while in p-type semiconductors the charge carriers are positively charged mobile holes. The n-type PbTe/p-type PbTe semiconductor pair is a well known example.

A thermoelectric (TE) converter can operate in both an electric generator and heat pumping mode. In a generator mode, one of the legs is electrically open and an electrical load is placed in series at this point. Heat is added to one junction and removed from the other. In a heat pumping mode, a D.C. source replaces the load and heat is actively transported from one junction to the other. A general review of thermoelectrics is given by Rowe (‘CRC Handbook of Thermoelectrics’, CRC Press, 1995).

### BRIEF SUMMARY OF THE INVENTION

The most fundamental embodiment of the present invention is a TE circuit that uses at least one extra, isothermal semiconductor. The extra semiconductor forms a conductive bridge at the two junctions of the circuit legs, and thereby forming a total of at least four semiconductor junctions over the complete circuit. For the circuit legs, a p- and n-type semiconductor pair is preferred in which the valence and conduction bands of the n-type are higher in energy (i.e. having a lower electron affinity) than those of the p-type leg. The isothermal semiconductor(s) may be either p- or n-type. If it is n-type, its conduction band lies below (i.e. having a higher electron affinity) that of the n-type leg, and if it is a p-type material, its valence band lies above (i.e. having a lower electron affinity) that of the p-type leg. This arrangement results in an increase thermal conversion efficiency in comparison to the corresponding TE circuit that does not have the isothermal semiconductor present.

### BRIEF DESCRIPTION OF THE DRAWINGS

FIG. 1 is a schematic representation of a standard thermoelectric circuit, with two semiconductors legs S₁ and S₂ forming two junctions. The junctions are embedded within two heat sinks at different temperatures T_{Hot} and T_{Cold}.

FIG. 2A to 2C illustrates the energy band profiles of (A) an isolated extrinsic, p-n junction, (B) the junction at equilibrium, and (C) the corresponding profile at a higher temperature in which the semiconductors are intrinsic.

FIG. 3 is a schematic view of a modified thermoelectric circuit having two semiconductors legs S₁ and S₂ and an intrajunction semiconductor S₃, forming two pairs of junctions at different temperatures T_{Hot} and T_{Cold}.

FIG. 4A to 4C illustrates the energy band profiles of (A) isolated p_{L}-n-n_{L} junctions, (B) the junctions at equilibrium at low temperature, and (C) the corresponding profiles at a higher temperature in which the semiconductors are intrinsic.

FIG. 5 is a schematic view of a thermoelectric circuit, with two semiconductors legs S₁ and S₂ and two intrajunction semiconductor S₃ and S₄, forming three junction pairs at different temperatures T_{Hot} and T_{Cold}.

FIG. 6A to 4C illustrates the energy band profiles of (A) the isolated p_{L}-p-n-n_{L} junctions, (B) the junctions at equilibrium, and (C) the corresponding profiles at a higher temperature in which the semiconductors are intrinsic.

FIG. 7A to 7B is a schematic view of the experimental arrangement of semiconductors, (A) with a conventional two semiconductor circuit S₁ and S₂ and (B) with additional isothermal semiconductor S₃. External copper leads and connector are indicated by the solid bars.

### DETAILED DESCRIPTION OF THE INVENTION

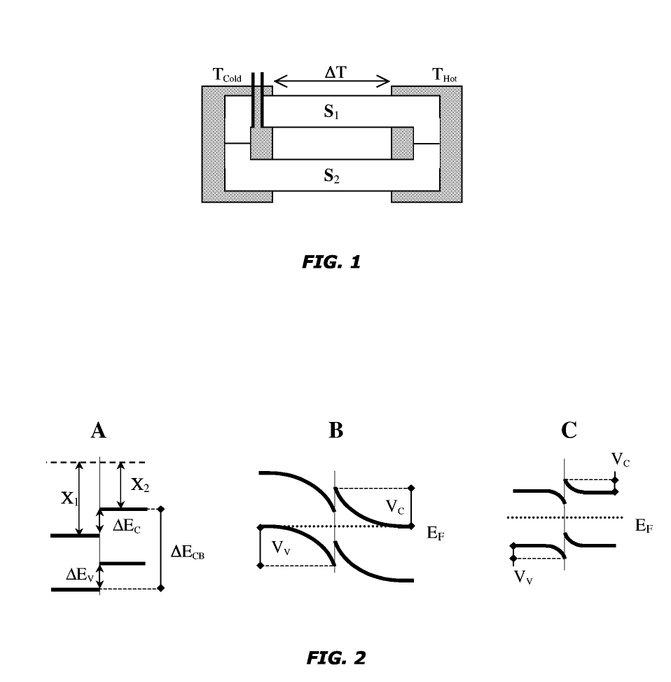

A schematic representation of a conventional thermoelectric circuit is shown in FIG. 1, where two homogenous conductors (the circuit legs), S₁ and S₂, are connected at two junctions at different temperatures (Tₕₒₜ and T_{cold} across a temperature difference ΔT). This temperature difference is induced by exchange of thermal energy with the surroundings by means of heat exchangers. There is shown a gap in conductor S₂ containing two external metallic contacts from which electrical power may either be extracted in a generator mode or added in a heat pumping mode. The exact position of the circuit opening is irrelevant, subject to the requirement that the temperature of the contacts should be identical. As indicated in the figure, the temperature variation occurs only along the circuit legs and all junctions are most preferably isothermal.

The optimum electronic parameters for S₁ and S₂ at any given temperature range are determined in a conventional manner. To summarize, the most important electronic parameters for semiconductors comprising the TE circuit are:

Impurity Ion Concentration, N_{D} or N_{A} The extrinsic carrier concentration influences the circuit resistivity, TE voltage and thermal conductivity. The first effect is in opposition to the latter two and an optimum value is often found to be about 10¹⁸-10²⁰ ionized impurities/cm³.

Band Gap, E_{g} The band gap determines the extent of the change in the carrier concentration across a temperature range ΔT. At a given value of ΔT and at an optimum value of N_{D} (or N_{A}), the most ideal band gap is generally restricted to known values. For example, near room-temperatures E_{g} is typically around 0.2 eV, while at temperatures near 500° C. a value of about 0.6 eV is more common.

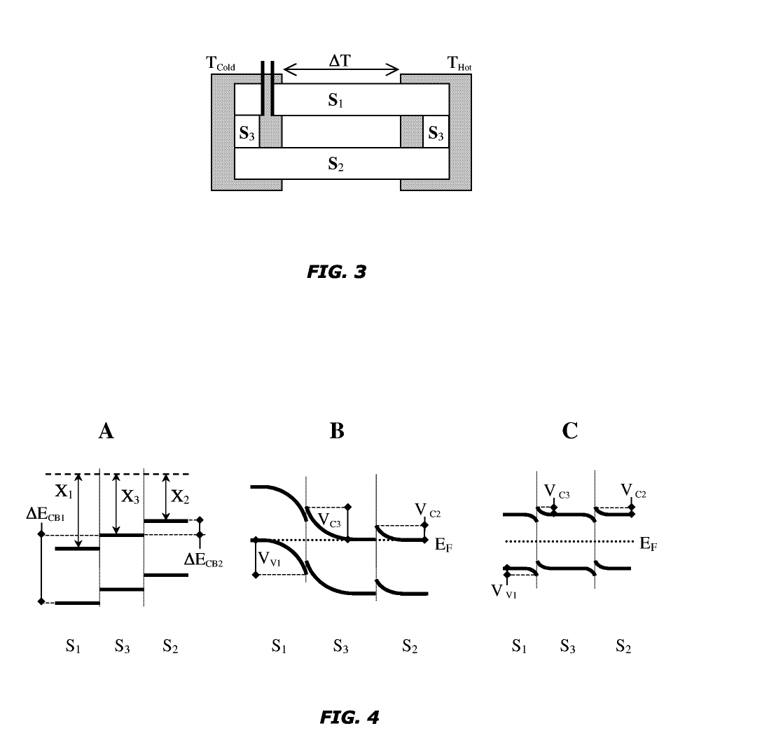

An additional electronic parameter, and one that is not conventionally considered important in a TE circuit, is the absolute energy of band edges. It is an essential aspect of the invention that there must be offset in the absolute energy of the band edges of S₁ and S₂. FIG. 2 is an illustration of the junction profiles for a hypothetical p-n semiconductor pair that conforms to the above requirements. The bulk energy bands of the two isolated semiconductors are shown in FIG. 2A, the equilibrium band profile at a relatively low temperature in FIG. 2B, and the profile at a much higher temperature in FIG. 2C. Illustrated in the figures are the respective electron affinities (X₁ & X₂), and the offset in the band energies, designated as ΔE_{C} and ΔE_{V} for the conduction and valence bands. Also illustrated is the difference in carrier band energies (ΔE_{CB}), the Fermi level (E_{F}), and the conduction and valence band components of the built-in junction potential (V_{C} and V_{V}).

The most basic embodiment of the invention essentially involves a modification of a standard TE circuit via a placement within the circuit junctions of an isothermal semiconductor of either n- or p-type. This is illustrated in FIG. 3 where the isothermal semiconductor is labeled as S₃. The positioning of S₃ within the junctions of the circuit legs is such that it is not subject to a thermal gradient and heat conduction occurs only through the circuit legs.

As previously stated, the circuit legs must have a substantial offset in their respective band energies. A second prerequisite for the invention is that the absolute band energies of S₃ should be intermediate to those of S₁ and S₂. Additionally, S₃ should also conform at least approximately to those electronic parameters listed above for the circuit legs. That is to say, its band gap and extrinsic carrier concentration are preferably similar to those of the circuit legs.

In FIG. 4 is shown of the junction profiles for an example p_{L}-n-n_{L} semiconductor configuration conforming to the above requirements, where there are p- and n-type circuit legs and n-type isothermal component (the L subscripts indicating these semiconductors are the circuit legs). The bulk energy bands of the isolated semiconductors are shown in FIG. 4A, the equilibrium band profiles at a relatively low temperature in FIG. 4B, and the profile at a much higher temperature in FIG. 4C. Illustrated in the figures are the respective electron affinities (Xᵢ) of each semiconductor, the offset in the carrier band energies (ΔE_{CB}), the Fermi level (E_{F}) at equilibrium, and the conduction and valence band components of each of the built-in junction potentials (V_{C} and V_{V}).

Device Fabrication

The circuit legs, isothermal semiconductors, and metallic leads may be constructed by conventional techniques. The semiconductor junctions are preferably fabricated in a way that minimizes cross-junction resistance, using techniques that can include vapor phase MBE and MOCVD. The optimal length and cross-sectional area of the circuit legs may be calculated in a conventional manner by consideration of the circuit Seebeck coefficient and figure of merit. The cross-sectional area of the isothermal semiconductor bridge should be similar to the legs and the thickness should at a minimum exceed the charge depletion depth at the junction.

As stated previously, semiconductors suitable for a particular temperature range may be chosen based upon the their known or predicted properties. Many semiconductors have been found suitable for thermoelectric conversion due to their good electrical to thermal conductivity ratios, and these include such materials as bismuth telluride alloys, skutterudites and clathrates. The existence of a band offset for a pair of semiconductors may be determined by experimental measurement via existing methods. Alternatively, a band offset may be predicted by a variety of known computational techniques, some of which are discussed by Magaritondo and Perfetti in ‘Heterojunction Band Discontinuities, Physics and Device Applications’, Elsevier Science Publishers, Ch. 2, 1987.

Scope of the Invention

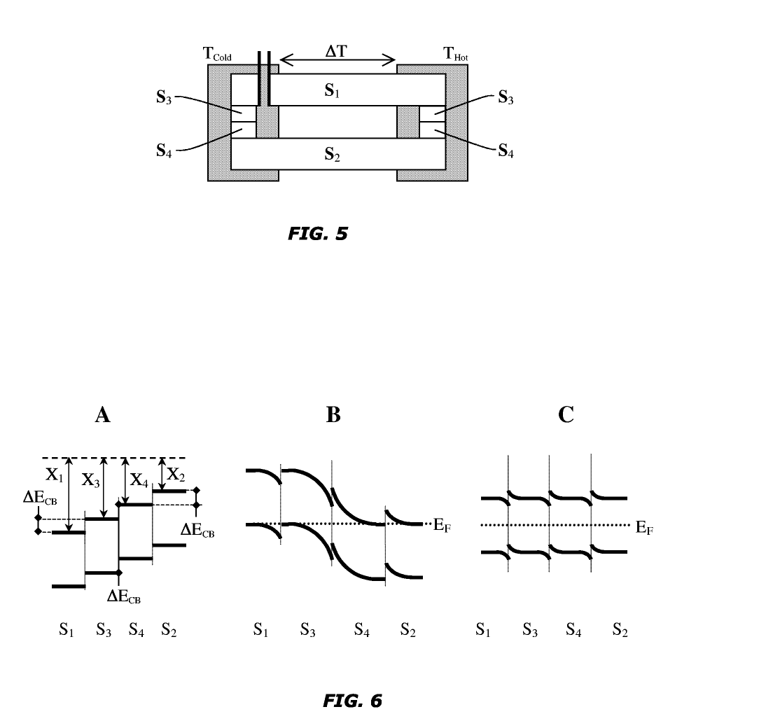

It is to be realized that only the preferred embodiments of the invention have been described and that numerous substitutions, alterations and modifications are permissible without departing from the spirit and scope of the invention as defined in the following claims. The above discussion was limited to a TE circuit incorporating a single n-type isothermal semiconductor. However, the circuit voltage and thermal efficiency may be further improved by insertion of more than one suitable semiconductor. Example configurations include P_{L}-P-P_{L}, n_{L}-n-n_{L} p_{L}-p-n-n_{L}, and p_{L}-p-n-n-n_{L}. For any particular case, each semiconductor should conform to the parameters outlined above. FIG. 5 is an illustration of the physical arrangement of a hypothetical p_{L}-p-n-n_{L} type circuit and FIG. 6 the relative band energies at the circuit junctions at both extreme high and low temperatures.

Additionally, the isothermal semiconductors need not be identical at the hot and cold junctions, although that is the preferred arrangement. All junctions are preferably fabricated as an abrupt transition from one semiconductor to the other, however a graded transition is also feasible.

Experimental Data

The following example is a demonstration of the invention. The semiconductors chosen for study were InSb and two Bi₂Te₃-based alloys. These were chosen because they both have a similar band gap energy, they were expected to have a substantial band offset and they were commercially available a relatively high carrier concentration (˜10¹⁸/cm³). The supplier was Girmet Ltd. (Moscow). The InSb was single crystal. The polycrystalline Bi₂Te₃ alloys were designated by Girmet as ‘B-grade’. The empirical formula of the n-type material was Bi₂Te_{2.7}Se_{0.3}, while the p-type was Bi_{0.5}Sb_{1.5}Te₃.

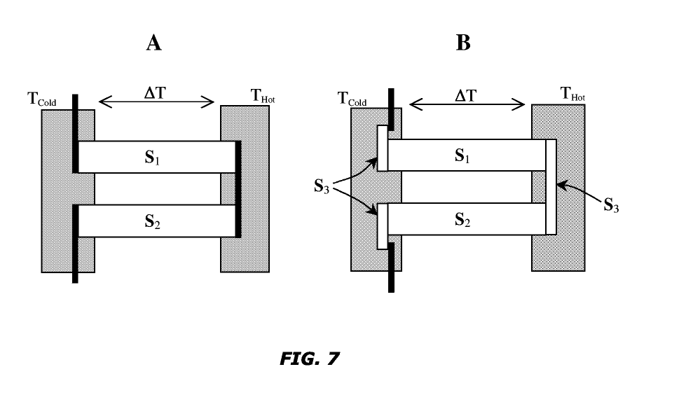

The experimental arrangements are illustrated schematically in FIGS. 7A & 7B. The leg elements S₁ and S₂ were p-InSb and n-Bi₂Te_{2.7}Se_{0.3}. Each was cut into rectangular pieces of 3×14 mm, with a thickness of 2.0 mm and 1.6 mm for p-InSb and n-Bi₂Te_{2.7}Se_{0.3}, respectively. The large ratio of length to cross-sectional area was chosen to greatly limit heat flow through the legs. The rectangular pieces were wrapped together with Mylar film using plastic spacer in between the two. Two large aluminum blocks were used as the heat sinks. Each block had a rectangular channel 4 mm deep and 3.5 mm wide that was filled with a thermal grease. A section of Mylar film was placed over the grease and the copper contacts and circuit legs were set into the channels and the blocks pressed together under spring tension. All junctions were by this arrangement completely surrounded by the heat sinks. Temperature measurement was made via thermocouples positioned in holes drilled into the aluminum blocks.

FIG. 7A is the conventional circuit arrangement. The circuit legs were electrically connected with a copper strip at the T_{Hot} sink and to two external copper leads at the T_{Cold} sink, from which for the open circuit voltage was measured. The voltages were measured by holding the T_{Cold} sink at 22° C. while varying the temperature of the T_{Hot} sink up to 60° C. An air-cooled heat exchanger was used to maintain T_{Cold} and a Peltier assembly was used to control T_{Hot}.

In FIG. 7B the copper strip at T_{Hot} was substituted with p-Bi_{0.5}Sb_{1.5}Te₃ and at T_{Cold} there were intermediate strips of p-Bi_{0.5}Sb_{1.5}Te₃ placed between the external copper leads and circuit legs. Thus, the p-Bi_{0.5}Sb_{1.5}Te₃ serves here as the intrajunction element S₃.

The Seebeck coefficient (α) was found to be significantly greater using p-Bi_{0.5}Sb_{1.5}Te₃ compared to copper. The measured Seebeck coefficients at a 95% confidence interval were:

| Isothermal Connector | α, mV/K |
|---|---|
| Copper | 0.275 ± 0.009 |
| p-Bi_{0.5}Sb_{1.5}Te₃ | 0.340 ± 0.026 |

It is to be realized that only the preferred embodiments of the invention have been described and that numerous substitutions, alterations and modifications are permissible without departing from the spirit and scope of the invention as defined in the following claims.

What is claimed is:

1. A thermoelectric apparatus including a thermoelectric circuit, a heat exchanging means for external exchange of thermal energy with said circuit, a conducting means for external exchange of electrical energy with said circuit, the thermoelectric circuit further comprising:
(a) at least two leg semiconductors having a substantial offset of their respective band energies, and
(b) at least one isothermal semiconductor electrically in series with the leg semiconductors, the isothermal semiconductor having band energies that are intermediate to those of the leg semiconductors.

2. The apparatus of claim 1, wherein the apparatus is a generator of electricity.

3. The apparatus of claim 1, wherein the apparatus is a heat pump.

4. The apparatus of claim 1, wherein the leg semiconductors are a p-n pair.

5. The apparatus of claim 1, wherein the leg semiconductors are selected from a group including the group (IIIA) tellurides, group (IVA) tellurides, group (VA) tellurides, silicon-germanium-tin alloys, skutterudites and clathrates.
